(19) United States
(12) Patent Application Publication
(10) Pub. No.: US 2005/0060475 A1
(43) Pub. Date: Mar. 17, 2005

(54) Data transfer apparatus and data transfer method

(75) Inventors: Yoko Yamamoto, Hyogo (JP); Yoshiteru Mino, Osaka (JP); Keizou Sumida, Osaka (JP)

Correspondence Address: McDERMOTT, WILL & EMERY, 600 13th Street, N.W., Washington, DC, 20005-3096, US

(73) Assignee: MATSUSHITA ELECTRIC INDUSTRIAL CO., LTD

(21) Appl. No.: 10/915,448

(22) Filed: Aug. 11, 2004

(30) Foreign Application Priority Data
Aug. 20, 2003 (JP) JP 2003-295967

(51) Int. Cl. G06F 13/00; G06F 13/14

(52) U.S. Cl. 710/305

(57) ABSTRACT

In a data transfer apparatus, an operation cycle number required to transfer data is reduced.

Since data transfer control means 110 is provided which controls access timing with respect to a transfer source and a transfer destination based upon transfer latency information 591 and 592, data outputted from a transfer source device 121 is directly acquired to a transfer destination device 122. As a result, data transfer time can be omitted which is required to temporarily store data into a data buffer, and since the data buffer is omitted, a circuit scale can be reduced and also data transfer time can be shortened.

### BACKGROUND OF THE INVENTION

1. Field of the Invention

The present invention is related to a data transfer apparatus and a data transfer method, in which data transfer operations among two, or more slave devices connected to a bus are carried out by a bus master.

2. Description of the Related Art

Conventionally, in this sort of data transfer apparatus, a bus master is equipped with a data buffer. While the data transfer apparatus executes a data transfer control operation by designating both an address of a transfer source slave device and an address of a transfer destination slave device, when a data transfer request is issued, data is temporarily stored from the transfer source slave device to the data buffer based upon the address of the transfer source, and the data stored in this data buffer is outputted to the transfer destination slave device based upon the address of the transfer destination (see, for example, Japanese Laid-open patent Application No. HEI-11-85670 (FIG. 1)).

However, in the above-described conventional data transfer apparatus, since the data buffer is provided, the cost required to mount this data buffer is increased. Also, since transfer cycle numbers are required so as to temporarily store data into the data buffer, which will be transferred, the data transfer cycle number is increased. This fact may cause a similar problem, namely a transfer cycle number is increased even in such a data transfer apparatus for performing a pipeline transfer operation in order to execute a data processing operation in a high speed.

### SUMMARY OF THE INVENTION

The present invention has an object to provide both a data transfer apparatus and a data transfer method, capable of deleting a data buffer, and also capable of decreasing a transfer cycle number required to transfer data.

To solve the above-described problem, a data transfer apparatus, according to the present invention, is featured by such a data transfer apparatus for transferring data between two, or more slave devices connected to a bus by a bus master, comprising: data transfer control means for controlling the bus in such a manner that data of a transfer source slave device is directly transferred to a transfer destination slave device in response to transfer information of the transfer source slave device and transfer information of the transfer destination slave device.

The data transfer control means may preferably control the bus in response to a difference between transfer latency of the transfer source slave device and transfer latency of the transfer destination slave device.

In this case, the data transfer control means may control the bus in response to transfer information outputted from the transfer source slave device and transfer information outputted from the transfer destination slave device.

Similarly, the data transfer control means may be preferably comprised of holding means for holding the transfer latency.

Furthermore, the data transfer control means may control the bus in response to the transfer latency held in the holding means, or the transfer information outputted from the slave device.

Also, the data transfer control means may preferably send a master ready signal used to control the transfer latency of the slave devices to either the transfer source slave device or the transfer destination slave device.

Moreover, the data transfer control means may control the bus in such a manner that the slave device, the transfer latency of which is small, is brought into a waiting state.

Also, the data transfer control means may preferably send a data output enable signal for controlling data output operation of the transfer source slave device, and sends a signal for switching address input operation of the transfer destination slave device.

In this case, the data transfer apparatus may preferably perform the data transfer operation between the slave devices in both a pipeline transfer mode and a data parallel transfer mode.

A data transfer method, according to the present invention, is featured by such a data transfer method in which data is transferred between two, or more slave devices connected to a bus by a bus master, comprising: a first step for acquiring transfer information of the transfer source slave device and transfer information of a transfer destination slave device; and a second step for controlling access timing of the bus in such a manner that the data of the transfer source slave device is directly transferred to the transfer destination slave device in response to the transfer information.

In this case, the second step includes: a step for calculating a difference between transfer latency of the transfer source slave device and transfer latency of the transfer destination slave device; and a step in which when the transfer latency of the transfer source slave device is smaller than the transfer latency of the transfer destination slave device, a data input operation of the transfer destination slave device is commenced; after a time period of the difference between the transfer latency has elapsed, a data output operation of the transfer source slave device is performed; when the transfer latency of the transfer source slave device is larger than the transfer latency of the transfer destination slave device, a data output operation of the transfer source slave device is commenced; and after the time period of the difference between the transfer latency has passed, a data input operation of the transfer destination slave device is carried out.

In accordance with the present invention, since the data transfer apparatus is arranged in such a manner that while the data buffer is not provided with the bus master, when the data transfer control operation is carried out by the bus master, the data is directly transferred from the transfer source slave device to the transfer destination slave device, such a data transfer time used to store the data into the data buffer employed in the bus master can be omitted, and thus, the data transfer time can be shortened. Also, since the data buffer is not employed in the data transfer apparatus, the circuit scale thereof can be reduced, and therefore, the mounting cost can be suppressed. As explained above, both the effect capable of increasing the data transfer speed and the effect capable of reducing the circuit scale can be achieved.

Also, in the case that the data transfer operations whose transfer systems are different from each other are continuously carried out, since the data transfer operations can be carried out at the optimum timing, the data transfer efficiency can be increased.

### BRIEF DESCRIPTION OF THE DRAWINGS

FIG. 1 is a diagram for showing a schematic arrangement of a data transfer apparatus according to an embodiment mode 1.

FIG. 2 is a diagram for indicating a concrete arrangement of the data transfer apparatus of FIG. 1.

FIG. 3 is a flow chart for describing a sequence of data transfer process operations.

FIG. 4 is a timing chart for representing changes contained in a transfer request command, an address bus, a data bus, and states of a state transition circuit in a data transfer operation.

FIG. 5 is a diagram for indicating state transitions of a state transition circuit 521.

FIG. 6 is a diagram for showing the schematic arrangement of the conventional data transfer apparatus.

FIG. 7 is a timing chart for representing changes contained in the transfer request command, the address bus, and the data bus in the conventional data transfer operation.

FIG. 8 is a diagram for indicating a concrete arrangement of a data transfer apparatus according to an embodiment mode 2.

FIG. 9 is a diagram for indicating a concrete arrangement of a data transfer apparatus according to an embodiment mode 3.

FIG. 10 is a diagram for indicating a schematic arrangement of a data transfer apparatus according to an embodiment mode 4.

FIG. 11 is a diagram for indicating a concrete arrangement of the data transfer apparatus according to the embodiment mode 4.

FIG. 12 is a timing chart for representing changes contained in a transfer request command, an address bus, a data bus, a master reading signal, and states of a state transition circuit in a data transfer operation.

FIG. 13 is a diagram for indicating a schematic arrangement of a conventional data transfer apparatus.

FIG. 14 is a timing chart for representing changes contained in a transfer request command, an address bus, and a data bus in a data transfer operation of the data transfer apparatus of FIG. 13.

FIG. 15 is a diagram for indicating a concrete arrangement of a data transfer apparatus according to an embodiment mode 5.

FIG. 16 is a timing chart for representing changes contained in a transfer request command, an address bus, a data bus, and states of a state transition circuit in a data transfer operation.

FIG. 17 is a diagram for indicating state transitions of a state transition circuit 1530.

FIG. 18 is a diagram for indicating a concrete arrangement of a data transfer apparatus according to an embodiment mode 6.

FIG. 19 is a timing chart for representing changes contained in a transfer request command, an address bus, a data bus, a data output enable signal, and a bus switch signal in a data transfer operation.

### DESCRIPTION OF THE PREFERRED EMBODIMENTS

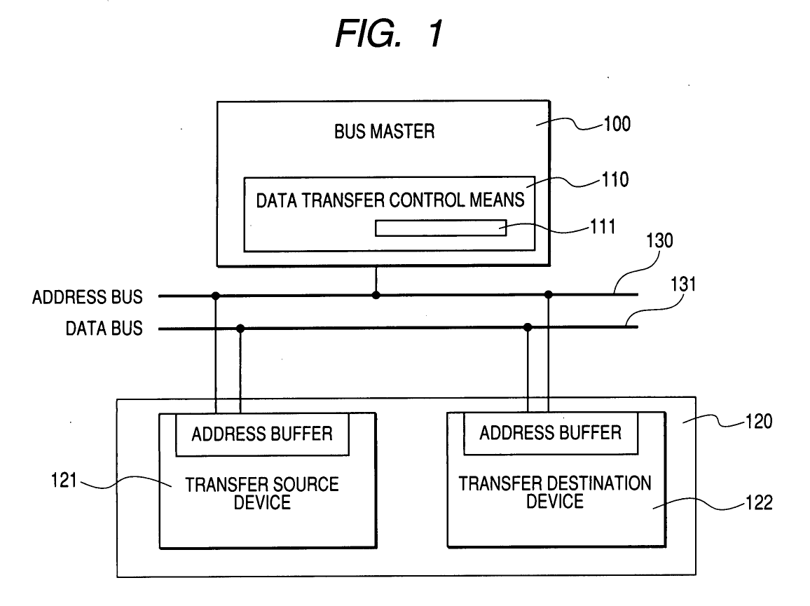

Referring now to drawings, embodiment modes as to a data transfer apparatus and a data transfer method, according to the present invention, will be described. FIG. 1 is a diagram for schematically showing an arrangement of a data transfer apparatus according to an embodiment mode 1. The data transfer apparatus is arranged by a bus master 100, a bus slave 120, an address bus 130, and a data bus 131. Both the bus master 100 and the bus slave 120 are connected to the address bus 130. The bus slave 120 is connected to the data bus 131.

The bus master 100 owns data transfer control means 110 which controls operation of the bus slave 120. A transfer information holding unit 111 is provided in this data transfer control means 110. On the other hand, the bus slave 120 is arranged by arbitrary plural sets of slave devices. In this embodiment mode, this bus slave 120 is arranged by two sets of slave devices, namely a transfer source device 121 and a transfer destination device 122. It should be noted that contents of both the data transfer control means 110 and the transfer information holding unit 111 will be explained later more in detail.

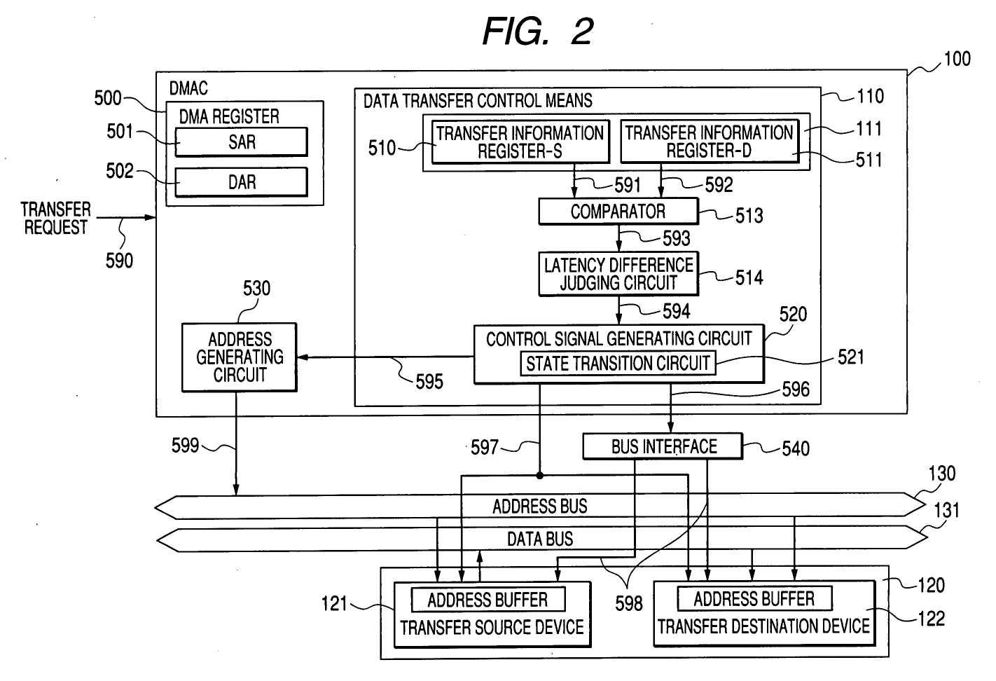

FIG. 2 is a diagram for showing a concrete arrangement of the data transfer apparatus of FIG. 1. In this concrete arrangement, such a case is shown that as the bus master 100, a DMAC (direct memory access controller) has been applied. The DMAC 100 functioning as the bus master contains a DMA register 500 and an address generating circuit 530 in addition to the above-explained data transfer control means 110. While a source address register (SAR) 501 and a destination address register (DAR) 502 are provided in the DMA register 500, DMA transfer operation information is set to these registers 501 and 502. Also, the address generating circuit 530 generates an address which is outputted to both the transfer source device 121 and the transfer destination device 122.

The data transfer control means 110 contains a comparator 513, a latency difference judging device 514, and a control signal generating circuit 520 in addition to the above-described transfer information holding unit 111. The data transfer control means 110 outputs an address generation control signal 595 to the address generating circuit 530, outputs a bus interface control signal 596 to the bus interface 540, and outputs a transfer request command 597 to both the transfer source device 121 and the transfer destination device 122.

In the transfer information holding unit 111, a transfer information register-“S” 510 and another transfer information register-“D” 511 are employed. Information as to transfer latency (transfer delay time) of the transfer source device 121 is set to the transfer information register-“S” 510. Also, information as to transfer latency of the transfer destination device 122 is set to the transfer information register-“D” 511. A state transition circuit 521 is provided in the control signal generating circuit 520.

Also, while a bus interface 540 is provided in the data transfer apparatus, this bus interface 540 outputs a selection signal 598 which is used to select such a slave device from the bus slave 120, to which data is transferred.

Next, operations of the data transfer control means 110 are indicated. When a data transfer request 590 is issued from a CPU (not shown), the transfer information holding unit 111 outputs both transfer information 591 of the transfer source device 121 supplied from the transfer information register-“S” 510, and transfer information 592 of the transfer destination device 122 supplied from the transfer information register-“D” 511 to the comparator 513.

When the transfer information 591 and the transfer information 592 are entered to the comparator 513, the comparator 513 performs such a calculation that a difference between the transfer information 591 and the transfer information 592 is calculated. Based upon this calculation result, the latency difference judging unit 514 performs a difference judgement of the latency. A difference judging result 594 is entered to the control signal generating circuit 520.

The state transition circuit 521 employed in the control signal generating circuit 520 operates based upon the difference judging result 594. Then, the control signal generating circuit 520 initiates a bus cycle at such a timing that data outputted from the transfer source device 121 is directly acquired by the transfer destination device 122, and generates the address generating circuit control signal 595, the bus interface control signal 596, and the transfer request command 597 so as to be outputted.

The address generating circuit 530 generates an access address in response to the timing of the address generating circuit control signal 595 based upon both an address value set to the source address register (SAR) 501 and an address value set to the destination address register (DAR) 502. Also, the bus interface 540 outputs the selection signal 598 to a device to which data should be transferred in response to the bus interface control signal 596. Since such a control operation is carried out, the data outputted from the transfer source device 121 may be directly acquired by the transfer destination device 122 without via the data buffer employed in the DMAC 100.

In accordance with the data transfer apparatus of the embodiment 1, the data transfer operation can be carried out at the optimum timing without via the data buffer in response to the difference between the transfer latency of the transfer source device and the transfer latency of the transfer destination device, which is different from the first-mentioned transfer latency.

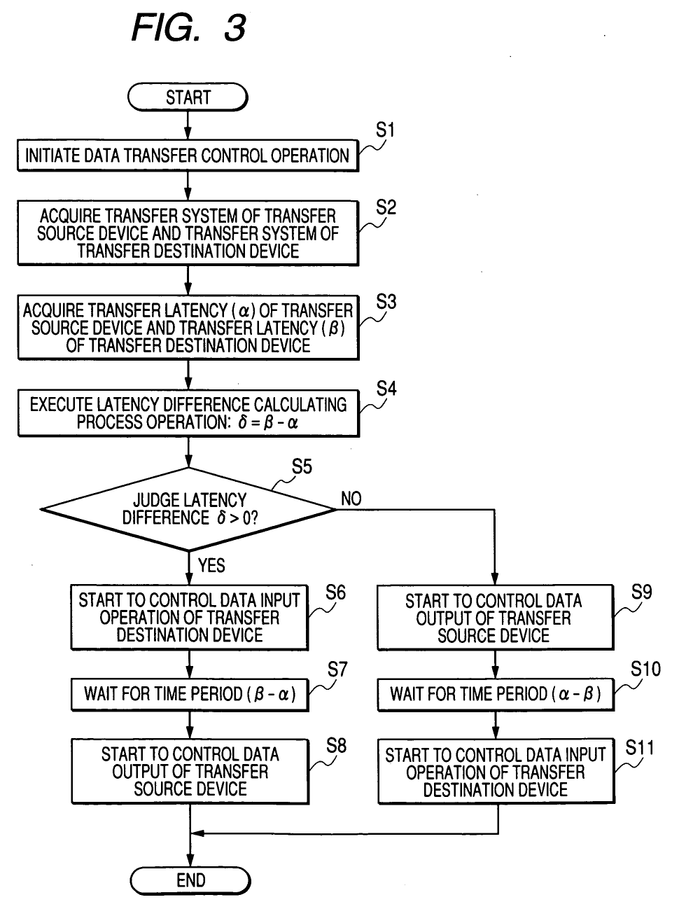

FIG. 3 is a flow chart for indicating a sequence of data transfer control process operations. First, when a transfer request is entered from the CPU (not shown) to the data transfer apparatus, the data transfer apparatus initiates a data transfer control operation (step S1). Then, the data transfer apparatus acquires both a transfer system of a transfer source device and a transfer system of a transfer destination device (step S2). In response to the acquired transfer system, timing of data input/output control operations in the transfer source device and the transfer destination device is changed, and then, the changed timing is fixed.

Then, the data transfer apparatus acquires transfer latency (α) of the transfer source device and transfer latency (β) of the transfer destination device (step S3). The data transfer apparatus executes a latency difference calculating process operation by employing the acquired transfer latency (step S4). In this latency difference calculating process operation, such a calculation of

δ=β−α is performed. The data transfer apparatus judges as to whether or not the difference (δ) corresponding to the latency difference result is equal to a positive value (step S5).

In the case that the difference (δ) is equal to the positive value, a data input control operation of the transfer destination device is commenced (step S6), and the transfer source device is brought into a waiting state only during a time period of (β−α) (step S7). Then, a data output control operation of the transfer source device is commenced, and then, data is directly acquired from the transfer source device to the transfer destination device (step S8). Thereafter, this data transfer control processing operation is ended.

On the other hand, in the case that the difference (δ) is not equal to the positive value, a data output control operation of the transfer source device is commenced (step S9), and the transfer destination device is brought into a waiting state only during a time period of (α−β) (step S10). Then, a data input control operation of the transfer destination device is commenced, and then, data is directly acquired from the transfer source device to the transfer destination device (step S11). Thereafter, this data transfer control processing operation is ended. It should be understood that this data transfer control processing operation is similarly carried out even in the subsequent embodiment modes. Also, in the embodiment mode 1, as will be explained later, such a case is indicated that the difference (δ) is equal to a negative value, and the data output control operation of the transfer source device is commenced in the beginning.

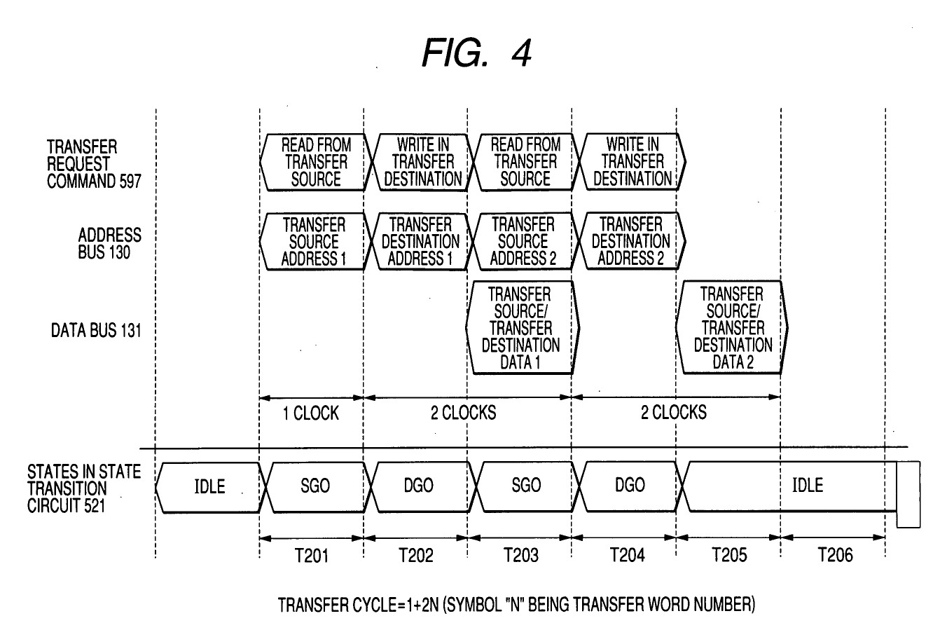

Next, timing of data transfer operations is represented. FIG. 4 is a timing chart for representing changes contained in a transfer request command, an address bus, a data bus, and states of the state transmission circuit in the data transfer operations. Such a timing case is shown in this data transfer operation. That is data read operation from the transfer source device corresponds to 3 cycles (T201 to T203, and T203 to T205), and data write operation to the transfer destination device corresponds to 2 cycles (T202 to T203, and T204 to T205).

When a data transfer control operation is initiated by the bus master (DMAC) 100, the data transfer control means 110 controls the timing of the bus based upon such transfer information as the data transfer system of the transfer source device 121, the data transfer system of the transfer destination device 122, the transfer latency of the transfer source device 121, the transfer latency of the transfer destination device 122, and the like, which have been set to the transfer information holding unit 111.

In other words, in this case, both of the transfer source device and the transfer destination device correspond to such devices operable in pipeline transfer operations and also fixed weight accesses, so that the state transition circuit 521 employed in the data transfer control means 110 judges that the data read operation from the transfer source device is equal to 3 cycles, and the data write operation to the transfer destination device is equal to 2 cycles. Thus, this state transmission circuit 521 controls the access timing with respect to the transfer destination device in such a manner that both the output timing of the data in the transfer source device 121 and the input timing of the data in the transfer destination device 122 may become the same cycles (T203 and T205).

As a consequence, while the data is transferred between the devices during which the data read operation from the transfer source device corresponds to 3 cycles and the data write operation to the transfer destination device corresponds to 2 cycles, a control operation is carried out in such a manner that the transfer destination address is outputted at the next cycles (T202, T204) of the cycles (T201, T203) used to output the transfer source address, so that both the output timing of the data in the transfer source device 121 and the input timing of the data in the transfer destination device 122 are adjusted, and thus, the data outputted from the transfer source device is directly acquired to the transfer destination device.

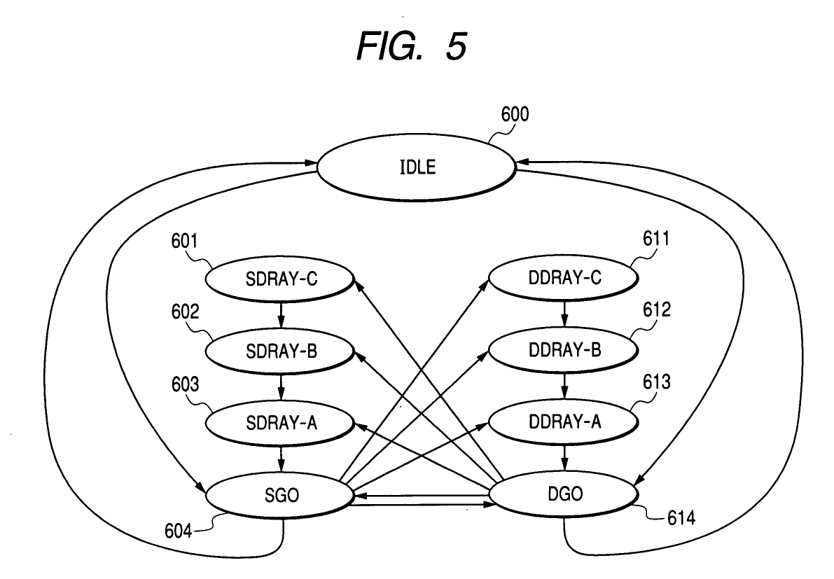

FIG. 5 is a diagram for indicating state transitions of the state transition circuit 521. In this drawing, an SGO state 604 corresponds to a state under which the state transition circuit 521 transits at source address output timing. A DGO state 614 corresponds to a state under which the state transition circuit 521 transits at destination address output timing. In this case, it is so assumed that a “source” indicates a transfer source, and a “destination” shows a transfer destination. The respective terms are used based upon the same definitions. Also, SDRAY-A603, SDRAY-B602, and SDRAY-C601 correspond to such states that the state transition circuit 521 transits when a source-sided device is brought into a waiting condition. DDRAY-A613, DDRAY-B612, and DDRAY-C611 correspond to such states that the state transition circuit 521 transits when a destination-sided device is brought into a waiting condition.

Based upon the latency difference judging result 594 of the latency difference judging unit 514, the state transition circuit 521 transits to any one of these states, namely, SDRAY-A603, SDRAY-B602, SDRAY-C601, DDRAY-A613, DDRAY-B612, and DDRAY-C611, and delays output timing of the transfer request command 597 and output timing of the address 599.

As a consequence, in the data transfer operation in the embodiment mode 1, as to the transfer latency, since the write cycle to the transfer destination device is smaller than the read cycle from the transfer source device by 1 cycle, both the transfer request command 597 to the transfer source device and the address 599 corresponding thereto are outputted in the SGO state 604. In the next cycle, the state transition circuit 521 transits to the DGO state 614, and outputs the transfer request command 597 to the transfer destination device and the address 599 corresponding thereto.

Since such a data transfer control operation is carried out, a total cycle number defined until the data (1 transfer word number) of the transfer source device 121 is stored in the transfer destination device 122 becomes 3 cycles, and this data is repeatedly pipeline-transferred, so that the data transfer cycle becomes 1+2N (symbol “N” being transfer word number) cycles.

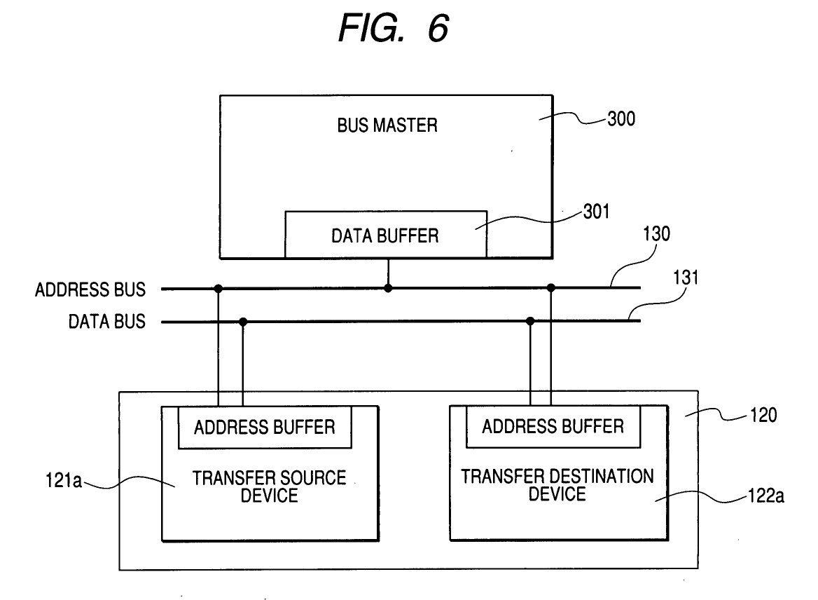

Now, there is shown a difference between the data transfer operation executed in the data transfer apparatus of the embodiment mode 1 and a data transfer operation executed in a conventional data transfer apparatus. FIG. 6 is a diagram for schematically showing an arrangement of a conventional data transfer apparatus. A bus master 300 provided in the conventional data transfer apparatus contains a data buffer 301. Data read from a transfer source device 121a is once buffered into the data buffer 301, and thereafter, is transferred to a transfer destination device 122a.

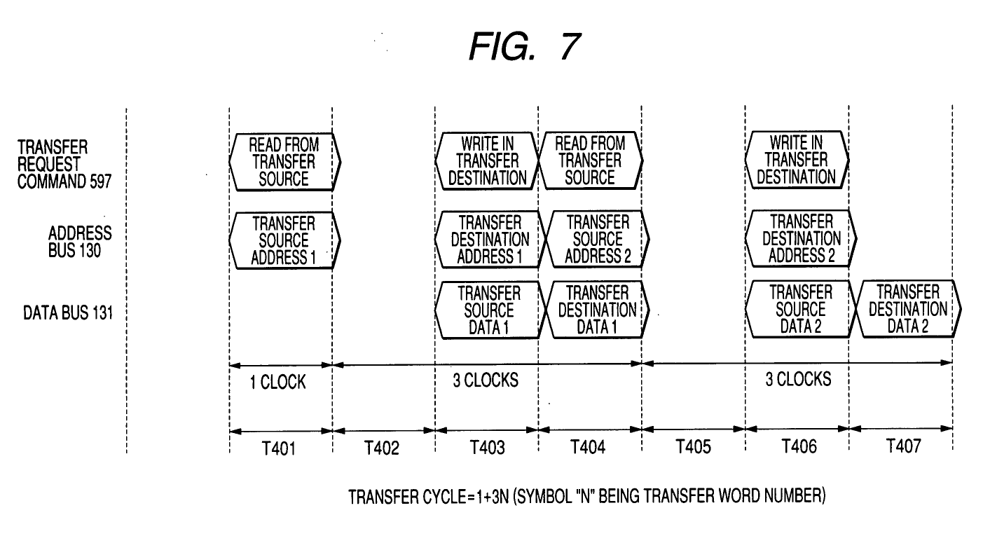

FIG. 7 is a timing chart for indicating changes as to a transfer request command, an address bus, and a data bus in the conventional data transfer operation. Similar to FIG. 4, FIG. 7 indicates such a case that data read operation from a transfer source device corresponds to 3 cycles (T401 to T403, and T404 to T406), and data write operation to a transfer destination device corresponds to 2 cycles (T403 to T404, and T406 to T407).

In the conventional data transfer apparatus, when the data of the transfer source device 121a is transferred to the transfer destination device 122a, the data is necessarily transferred via the data buffer 301. As a result, while the data is transferred from the transfer source device 121a to the data buffer 301, the bus is occupied, so that the present transfer cycle cannot be advanced to the transfer destination device 122a. As a consequence, in the conventional data transfer apparatus, 4 cycles are consumed until the data read from the transfer source device is stored into the transfer destination device, and when the data is transferred in the pipeline transfer mode, the data transfer cycle becomes “1+3N (symbol “N” being transfer word number)” cycles.

As apparent from a comparison made between the timing chart of FIG. 4 and the timing chart of FIG. 7, since the data transfer apparatus of this embodiment mode 1 is not provided with such a data buffer for temporarily buffering data, data transfer time required to temporarily buffer the data can be omitted, and the data transfer apparatus can perform the data transfer operation at the optimum timing with respect to the slave device. As a consequence, the data transfer time can be shortened. Also, since the operation cycle number required to execute the data transfer operation can be reduced, this may improve the data transfer efficiency.

It should also be noted that the data transfer operation of the data transfer apparatus according to the embodiment mode 1 is directed to the above-described slave device. Even in such a data transfer operation of a device having another fixed wait access number, in the case that a read cycle number of data from a transfer source device is different from a write cycle number of data into a transfer destination device, an address output cycle to the transfer destination device is controlled in such a manner that both output timing of data in the transfer source device and input timing of data in the transfer destination device become the same cycles, so that a high-speed data transfer operation can be realized without through such a data buffer.

Also, such an assumption is made in the embodiment mode 1 as follows. That is, both the transfer source device 121 and the transfer destination device 122 are the pipeline-transfer-operable devices. The present invention may be applied to such a case that at least any one of the transfer source device and the transfer destination device corresponds to such a pipeline-transfer-operable device. Furthermore, the present invention may be alternatively applied to such a case that three, or more slave devices are employed. In this alternative case, such a notification maybe issued to the data transfer control means 110, which notifies that which slave device among the plural slave devices may become a transfer source device, or a transfer destination device. For example, while identification codes (IDs) are exclusively provided with respect to the respective slave devices, these identification codes are set to the transfer information holding unit 111, so that the present invention may be alternatively applied with respect to a set of arbitrarily selected slave devices among a plurality of slave devices.

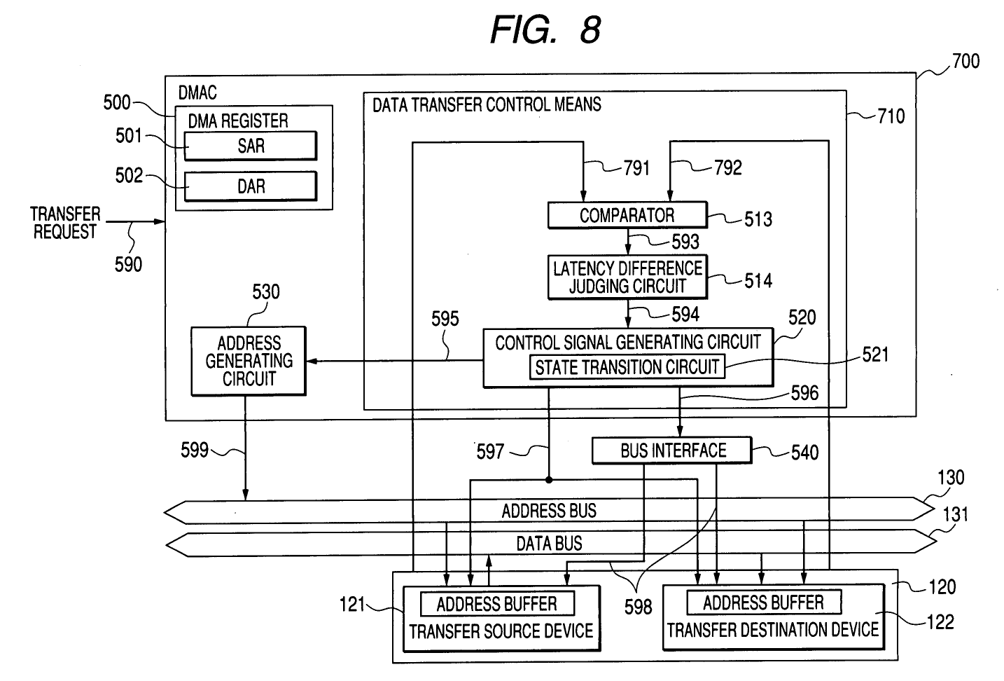

FIG. 8 is a diagram for indicating a concrete arrangement of a data transfer apparatus according to an embodiment mode 2. It should be noted that the same reference numerals shown in the above-described embodiment mode 1 will be employed as those for denoting the same, or similar structural elements indicated in the embodiment mode 2, and descriptions thereof are omitted. Similar to the embodiment mode 1, in the embodiment mode 2, a DMAC is employed as a bus master. Also, different from the embodiment mode 1, in this embodiment mode 2, no data transfer information holding unit is provided in the data transfer control means 710, but instead of this data transfer information holding unit, both transfer information 791 from the transfer source device 121 and transfer information 792 from the transfer destination device 122 are supplied to the comparator 513.

Also, there is such a case that the transfer information 791 and the transfer information 792 are different from each other every transfer cycle, and thus, the data control unit 710 may dynamically control data transfer operations in accordance with the transfer information 791 and 792. Other data transfer operations are similar to those of the embodiment mode 1.

In accordance with the data transfer apparatus of the embodiment mode 2, the transfer information as to transfer latency of a transfer source device and transfer latency of a transfer destination device is not previously acquired. Alternatively, even in such a case that transfer latency is changed every data transfer operation, the data transfer apparatus may perform the data transfer operation at optimum timing without via such a data buffer.

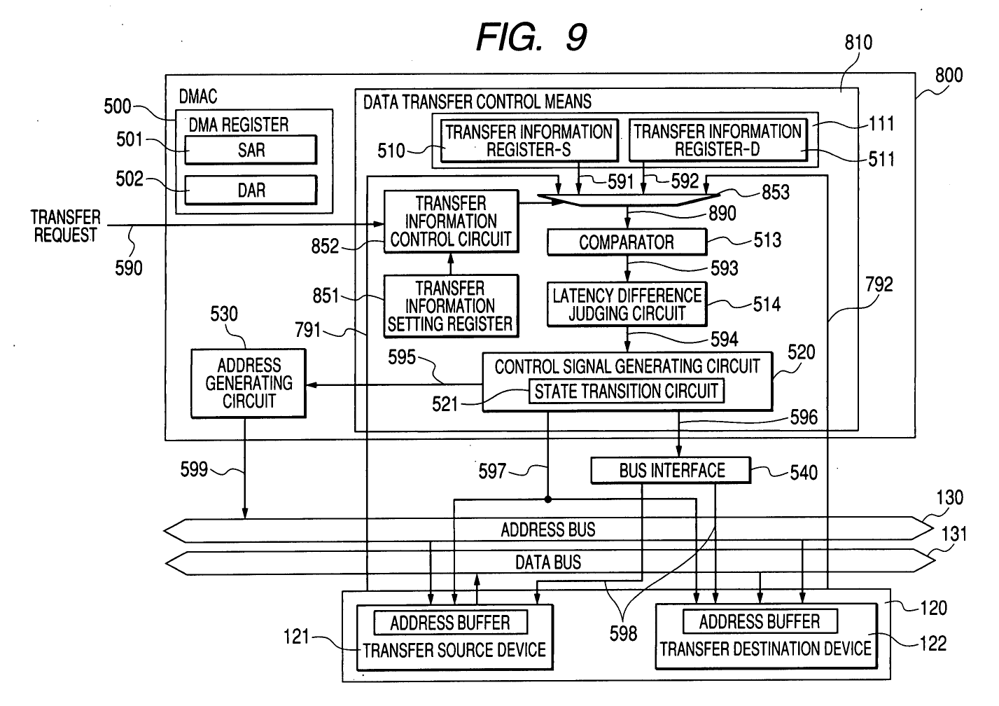

FIG. 9 is a diagram for indicating a concrete arrangement of a data transfer apparatus according to an embodiment mode 3. It should be noted that the same reference numerals shown in the above-described embodiment mode 1 will be employed as those for denoting the same, or similar structural elements indicated in the embodiment mode 3, and descriptions thereof are omitted. Similar to the embodiment mode 1, in the embodiment mode 3, a DMAC is employed as a bus master.

Also, different from the embodiment mode 1, in this embodiment mode 3, data transfer control means 810 contains a transfer information setting register 851, a transfer information control circuit 852, and a multiplexer 853. As a consequence, when the transfer information control circuit 852 receives a data transfer request 590 issued from a CPU (not shown), this transfer information control circuit 852 judges a reference destination of transfer information of a device to which data should be transferred based upon a set value of the transfer information setting register 851, and then outputs transfer information 890 of the transfer source device 121 and the transfer destination device 122 to the comparator 513.

In this embodiment mode 3, as the transfer information 890, the multiplexer 853 selects any one of the transfer information 591 corresponding to the output of the transfer information register-“S” 510 to which the transfer information of the transfer source device has been set, the transfer information 592 corresponding to the output of the transfer information register-“D” 511 to which the transfer information of the transfer destination device has been set, the transfer control information 791 outputted from the transfer source device 121, and the transfer control information 792 outputted from the transfer destination device 122 in response to a designation issued from the transfer information control circuit 852 based upon the set value of the transfer information setting register 851, and then supplies the selected information to the comparator 513. Other data transfer operations of this embodiment mode 3 are similar to those of the above-described embodiment mode 1.

In accordance with the data transfer apparatus of the embodiment mode 3, the data transfer operation can be carried out at the optimum timing without via a data buffer between such a slave device that transfer latency thereof is varied every data transfer operation, and another slave device in which transfer information such as transfer latency is not outputted, and the transfer latency is fixed.

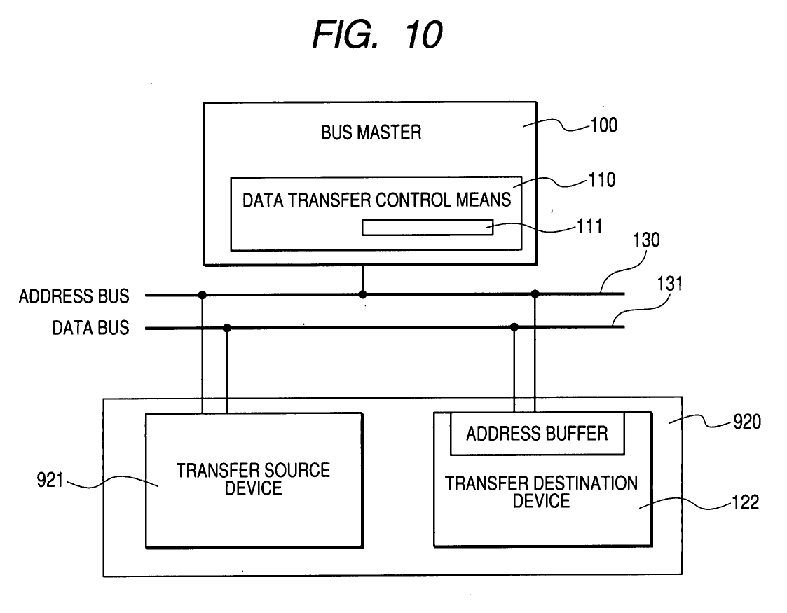

FIG. 10 is a diagram for indicating an abstract arrangement of a data transfer apparatus according to an embodiment mode 4. It should be noted that the same reference numerals shown in the above-described embodiment mode 1 will be employed as those for denoting the same, or similar structural elements indicated in the embodiment mode 4, and descriptions thereof are omitted. Similar to the embodiment mode 1, in the embodiment mode 4, a DMAC is employed as a bus master.

Also, a transfer source device 921 employed in the embodiment mode 4 is different from the transfer source device 121 of the embodiment mode 1, but corresponds to such a slave device which is not operable in a pipeline transfer mode. On the other hand, similar to the embodiment mode 1, the transfer destination device 122 is such a slave device which is operable in the pipeline transfer mode, and the transfer latency of which can be controlled.

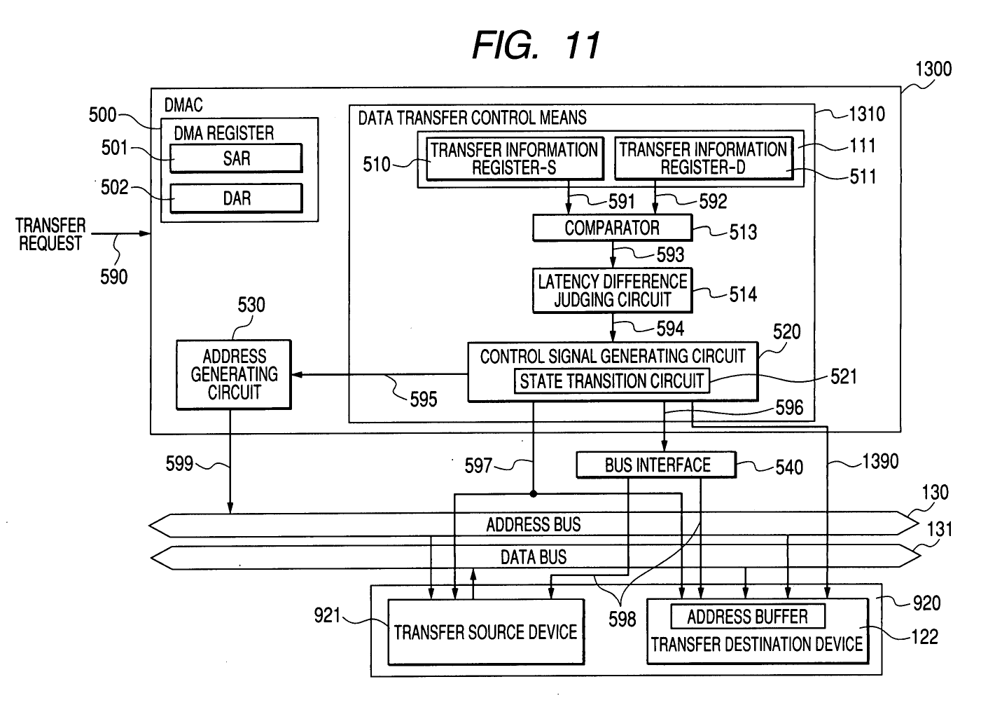

FIG. 11 is a diagram for indicating a concrete arrangement of the data transfer apparatus according to the embodiment mode 4. Different from the embodiment mode 1, in this embodiment mode 4, data transfer control means 1310 outputs a master ready signal 1390 so as to control transfer latency with respect to the transfer destination device 122 which is operable in the pipeline transfer mode, and the transfer latency of which can be controlled.

Similar to the embodiment mode 1, in the data transfer control means 1310, when both the transfer information 591 and the transfer information 592 are entered to the comparator 531 in response to the data transfer request 590 issued from a CPU (not shown), a calculation is carried out by the comparator 513, and the latency difference judging unit 514 performs a latency difference judgment.

When a latency difference judging result 594 derived from the latency difference judging unit 514 is outputted to the control signal generating circuit 520, the state transition circuit 521 employed in the control signal generating circuit 520 is operated in response to this latency difference judging result 594, and generates the address circuit control signal 595, the bus interface control signal 596, and the transfer request command 597 in such a manner that data outputted from the transfer source device 921 is directly acquired by the transfer destination device 122, and then outputs these generated control signals and command.

In the embodiment mode 4, in addition to these control signals, the master ready signal 1390 is outputted with respect to the transfer destination device 122 which is operable in the pipeline transfer mode, and the transfer latency of which can be controlled. When this master ready signal 1390 is outputted, the transfer destination device 122 delays the transfer latency in accordance with the master ready signal 1390 so as to adjust the data input timing. As a result, the data outputted from the transfer source device 921 is directly acquired to the transfer destination device 122.

In accordance with the data transfer apparatus of the embodiment mode 4, since the transfer latency of the slave device is delayed in response to the difference between the transfer latency of the transfer source device and the transfer latency of the transfer destination device, the free degree of the transfer latency can be increased. Even when the devices whose minimum transfer latency is identical to each other are employed, the data transfer apparatus can perform the data transfer operation at the optimum timing without via such a data buffer. It should be noted that the above-described embodiment mode 4 shows such a case that the master ready signal is outputted to the transfer destination device. Alternatively, in such a case that a transfer source device is operable in the pipeline transfer mode, and transfer latency thereof can be controlled, the data transfer apparatus may be arranged in such a manner that the master ready signal is outputted to the transfer source device. Furthermore, the transfer apparatus may be arranged in such a manner that the master ready signal is outputted to both a transfer source device and a transfer destination device.

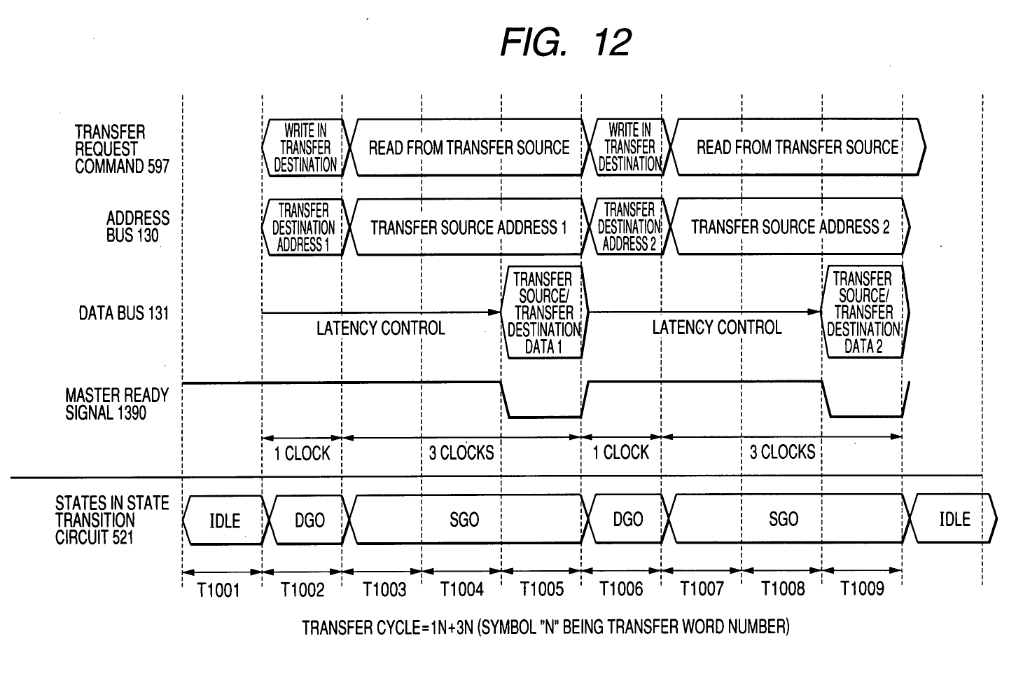

FIG. 12 is a timing chart for indicating changes contained in a transfer request command, an address bus, a data bus, a master ready signal, and states of the state transition circuit. A data read operation from a transfer source device requires 3 cycles, and a data write operation to a transfer destination device requires 2 cycles at a minimum. A data transfer operation is delayed to 4 cycles by the master ready signal 1390.

When the data transfer control operation by the bus master 1300 is initiated, the state transition circuit 521 judges that the transfer source device 921 is not operable in the pipeline transfer mode, but also, the transfer destination device 122 is operable in the pipeline transfer mode and the transfer latency of which can be controlled based upon the transfer information. Also, the bus master 1300 judges such a data transfer operation that the data read operation from the transfer source device 921 requires 3 cycles, and the data write operation to the transfer destination device 122 requires 2 cycles at a minimum based upon the transfer information. This transfer information contains the data transfer system of the transfer source device 921 which has been set to the transfer information holding unit 111, the data transfer system of the transfer destination device 122, and the transfer latency of the transfer source device 921, the minimum transfer latency of the transfer destination device 122, and the like.

Then, the access timing to the transfer destination device is controlled in such a manner that the data output timing in the transfer source device 921 and the data input timing in the transfer destination device 122 become the same cycles.

That is to say, since such a control operation is carried out in such a manner that the transfer destination address is outputted at a cycle (T1002 and T1006) before the transfer source address is outputted, and the master ready signal 1390 is asserted (valiated) at a third cycle (T1005 and T1009) after the transfer destination address has been outputted, both the data output timing in the transfer source device 921 and the data input timing in the transfer destination device 122 are adjusted, and thus, the data outputted from the transfer source device can be directly acquired to the transfer destination device.

Since such a data transfer control operation is carried out, a total cycle number required to store one word data transferred from the transfer source device 921 into the transfer destination device 122 becomes 4 cycles. Since this one word data is repeatedly transferred in the pipeline mode, a total data transfer cycle becomes (1N+3N) cycles in which symbol “N” indicates a transfer word number.

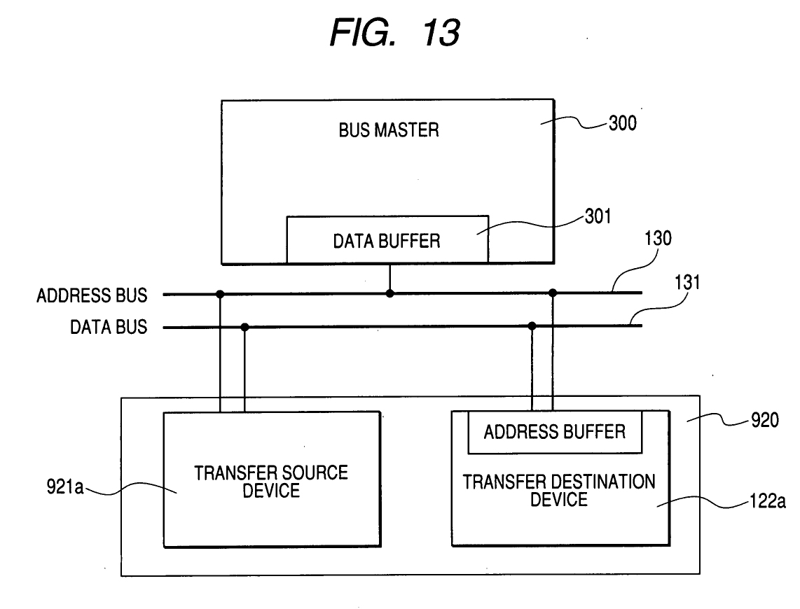

Now, there is shown a difference between the data transfer operation executed in the data transfer apparatus of the embodiment mode 4 and a data transfer operation executed in a conventional data transfer apparatus. FIG. 13 is a diagram for schematically showing an arrangement of a conventional data transfer apparatus. A bus master 300 provided in the conventional data transfer apparatus contains a data buffer 301. Data read from a transfer source device 921a is once buffered into the data buffer 301, and thereafter is transferred to a transfer destination device 122a.

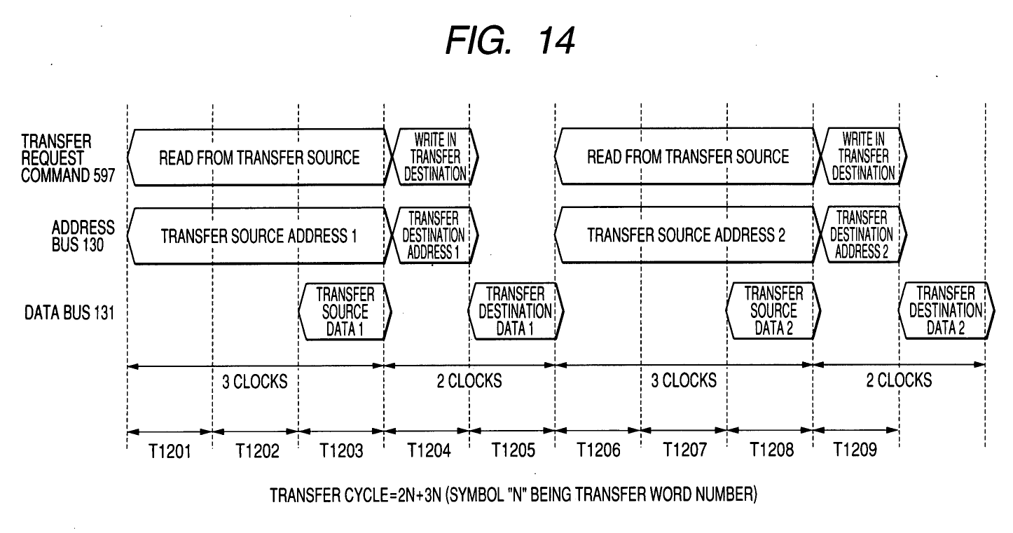

FIG. 14 is a timing chart for indicating changes as to a transfer request command, an address bus, and a data bus in a data transfer operation of the data transfer apparatus shown in FIG. 13. In this data transfer operation, 5 cycles are consumed until one word data transferred from the transfer source device 921a is stored into the transfer destination device 122a. In the case that this one word data is continuously transferred, (2N+3N) cycles are required in the data transfer operation, in which symbol “N” indicates a transfer word number.

As apparent from a comparison between the timing chart of FIG. 12 and the timing chart of FIG. 14, since the data transfer apparatus according to the embodiment mode 4 is not equipped with a data buffer for temporarily storing thereinto data, the data transfer operation can be carried out at the optimum timing by controlling the transfer latency, so that the data transfer time can be shortened. As a consequence, since the operation cycle number required to transfer the data can be reduced, the data transfer efficiency can be improved.

It should be understood that the data transfer operation of FIG. 12 is merely one example. Therefore, even in a data transfer operation between devices having other transfer latency than the above-described transfer latency, a high-speed data transfer operation may be alternatively realized without via a data buffer by controlling the transfer latency in such a manner that both the data output timing in the transfer source device 921 and the data input timing in the transfer destination device 122 become the same cycle.

Also, in the embodiment mode 4, the transfer source device 921 corresponds to such a device which is not operable in the pipeline transfer mode, whereas the transfer destination device 122 corresponds to such a device which is operable in the pipeline transfer mode, and the transfer latency of which can be controlled. However, the present invention is not limited only to such an arrangement. That is, as explained above, at least any one of the transfer source device and the transfer destination device may be such a device which is operable in the pipeline transfer mode, and the transfer latency of which can be controlled, to which the present invention may be similarly applied.

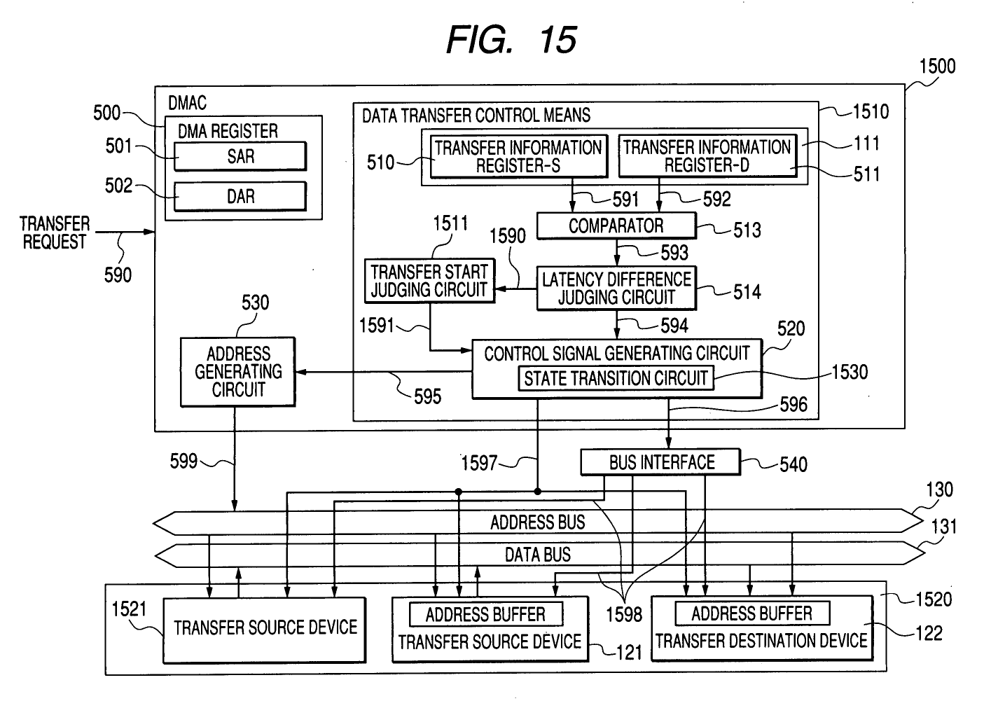

FIG. 15 is a diagram for indicating a concrete arrangement of a data transfer apparatus according to an embodiment mode 5. It should be noted that the same reference numerals shown in the above-described embodiment mode 1 will be employed as those for denoting the same, or similar structural elements indicated in the embodiment mode 5, and descriptions thereof are omitted. Similar to the embodiment mode 1, in the embodiment mode 5, a DMAC is employed as a bus master.

Also, different from the embodiment mode 1, in this embodiment mode 5, a transfer source device 1521 which is not operable in the pipeline transfer mode is additionally provided with a bus slave 1520, and three slave devices are connected to both the address bus 130 and the data bus 131. Also, the data transfer control means 1510 is equipped with a transfer start judging circuit 1511. In the case that data transfer operations by different transfer systems are mixed with each other, the data transfer control means 1510 judges start timing of the next data transfer operation.

The transfer start judging circuit 1511 judges both a transfer system of a preceding data transfer operation and a transfer system of a next data transfer operation, for instance, judges as to whether the transfer system corresponds to a pipeline transfer system, or a data parallel transfer system based upon a judging result 1590 of the latency difference judging unit 514. In response to these transfer systems, the transfer start judging circuit 1511 judges an output wait cycle number of a next transfer request command 1597, and outputs a transfer starting signal 1591 to the control signal generating circuit 520. The control signal generating circuit 520 causes a state transition circuit 1530 to be operated in accordance with the transfer starting signal 1591 so as to output a transfer request command 1597.

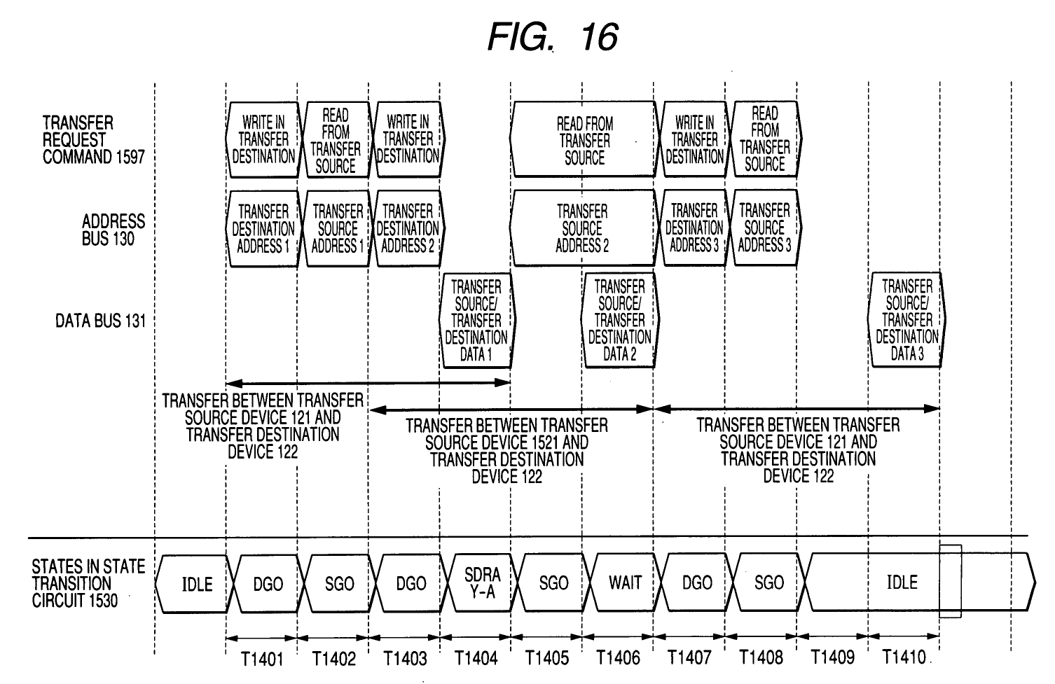

FIG. 16 is a timing chart for indicating changes contained in a transfer request command, an address bus, a data bus, and states of the state transition circuit. In a continuous data transfer operation between slave devices, the transfer source device 121 is such a device which is operable in the pipeline transfer mode, and a data read operation thereof requires 3 cycles. The transfer source device 1521 is such a device which is not operable in the pipeline transfer mode, and a data read operation thereof requires 2 cycles. The transfer destination device 122 is such a device which is operable in the pipeline transfer mode, and a data write operation thereof requires 4 cycles.

First, when the data transfer control operation by the bus master 1500 is initiated, as a first data transfer operation, a data transfer operation is carried out between the transfer source device 121 and the transfer destination device 122 (T1401 to T1404). While the first data transfer operation is carried out, when a second data transfer request is issued in order to transfer data between the transfer source device 1521 and the transfer destination device 122, the transfer start judging circuit 1511 judges a wait cycle number until a transfer request command 1597 for the second data transfer operation based upon the information as to the first transfer system and the second transfer system, and then, outputs a transfer starting signal 1591 to the control signal generating circuit 520. Then, the state transition circuit 1530 is operated.

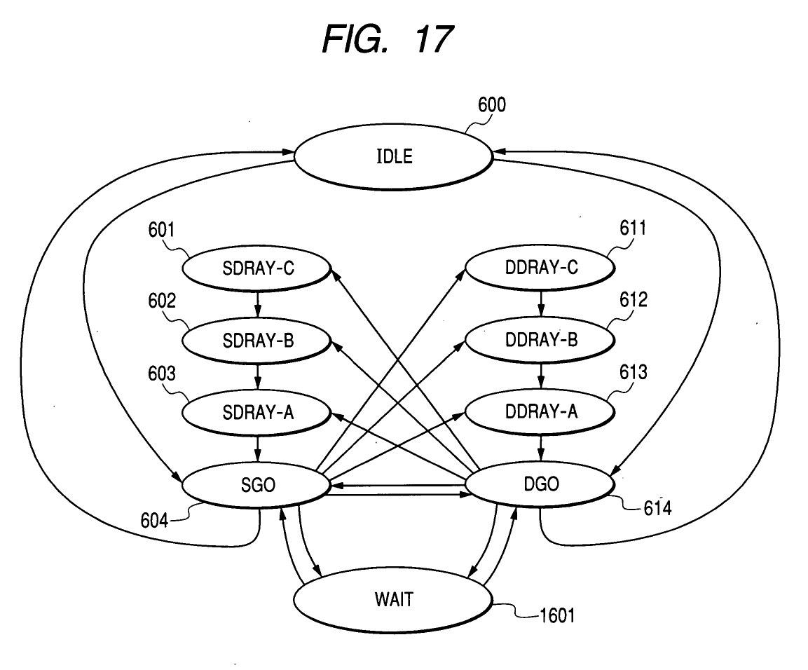

FIG. 17 is a diagram for indicating state transitions of the state transition circuit 1530. In response to the transfer starting signal 1591, the operation state of the state transition circuit 1530 has been firstly transited to a DGO state 614 (T1401) under which a transfer destination address of a first data transfer operation is outputted, and has been subsequently transited to an SGO state 604 (T1402) under which a transfer source address is outputted. Thereafter, since the first data transfer operation corresponds to a pipeline transfer operation and the second data transfer operation corresponds to a pipeline not-operable transfer operation, the operation state of this state transition circuit 1530 is transited to a DGO state (T1403) under which a transfer destination address of a second data transfer operation is outputted without waiting operation in order to subsequently execute the data transfer operation.

Thereafter, due to a difference of the transfer latency, in order to delay outputting operation of the transfer destination address of the second data transfer operation, the operation state of the state transition circuit 1530 is transited to an SDRAY-A state 603 (T1404), and furthermore, is transited to an SGO state 604 (T1405) under which a transfer source address is outputted.

While the second data transfer operation is carried out, when a third data transfer request is issued so as to transfer data between the transfer source device 121 and the transfer destination device 122, the transfer start judging circuit 1511 judges a wait cycle number until a third transfer request command 1597 is outputted based upon the information as to the second transfer system and the third transfer system, and then outputs the transfer starting signal 1591 to the control signal generating circuit 520. Then, the state transition circuit 1530 is operated.

In response to the transfer starting signal 1591, after the operation state of the state transition circuit 1530 has been transited from the SGO state 604 (T1405) under which the transfer source address of the second transfer operation is outputted to a WAIT state 1601 (T1406) under which since the second data transfer operation is not performed in the pipeline transfer mode, an access operation of the third data transfer operation is waited until the second data transfer operation is ended, the operation state of this state transit circuit 1530 is transited to a DGO state 614 (T1407) under which a transfer destination address of the third data transfer operation is outputted.

In accordance with the data transfer apparatus 1500 of the embodiment mode 5, since the bus cycle is initiated at the optimum timing in the continuous data transfer operations with the different transfer systems, the data transfer efficiency can be improved. It should also be understood that in the above-described embodiment mode 5, the three slave devices are provided. Alternatively, even when four, or more slave devices whose transfer systems are different are provided, the optimum data transfer operation may be similarly realized.

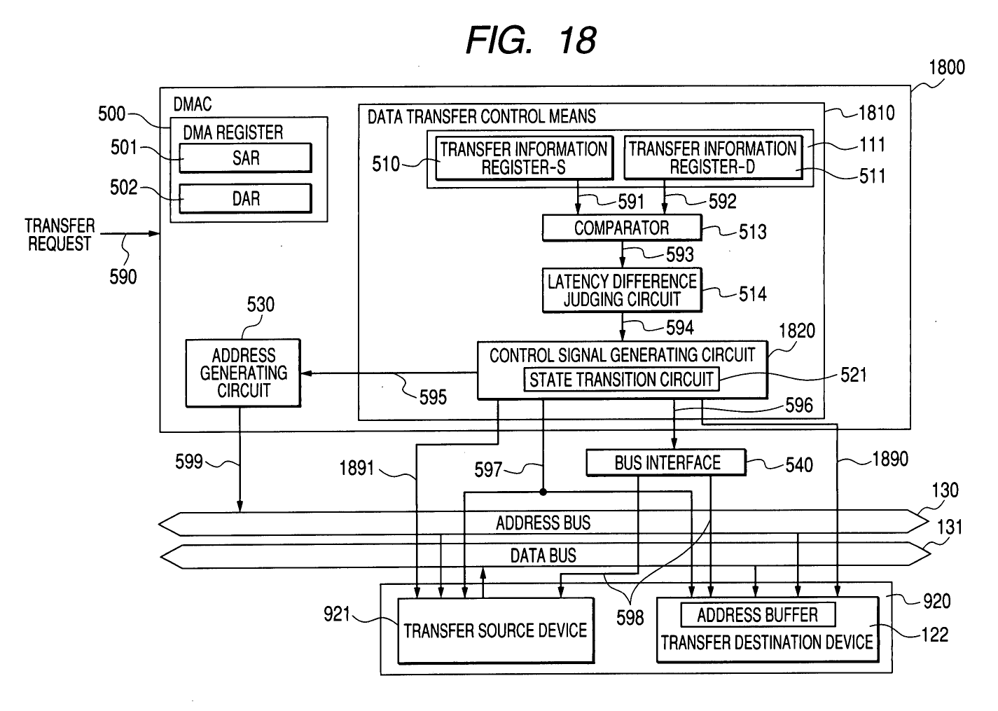

FIG. 18 is a diagram for indicating a concrete arrangement of a data transfer apparatus according to an embodiment mode 6. It should be noted that the same reference numerals shown in the above-described embodiment mode 1 will be employed as those for denoting the same, or similar structural elements indicated in the embodiment mode 6, and descriptions thereof are omitted. Similar to the embodiment mode 4, in the embodiment mode 6, a DMAC is employed as a bus master.

In the data transfer apparatus of the embodiment mode 6, data transfer control means 1810 employed in the bus master 1800 outputs an address which is outputted to a transfer destination device to a data bus so as to access both the transfer source device 921 and the transfer destination device 122 at the same time. As a result, a data transfer speed can be furthermore improved, as compared with that of the embodiment mode 4.

Also, different from the embodiment mode 4, in this embodiment mode 6, when the data transfer control means 1810 outputs any one of addresses to be outputted to the transfer source device 921 and the transfer destination device 122 to the data bus 131, this data transfer control means 1810 outputs a bus switch signal 1890 to the transfer destination device 122, and also, outputs a data output enable signal 1891 to the transfer source device 921 in order to avoid that the address collides with the data on the data bus 131.

In the data transfer control means 1810, when a data transfer request 590 is issued from a CPU (not shown), both the transfer information 591 and the transfer information 592 are entered to the comparator 513, a calculation is carried out by the comparator 513. Based upon this calculation result, the latency difference judging unit 514 executes a latency difference judging operation. When this latency difference judging result 594 is outputted to the control signal generating circuit 1820, the state transition circuit 521 employed in the control signal generating circuit 1820 is operated in response to the latency difference judging result 594, and executes a data transfer control operation in such a manner that the data outputted from the transfer source device 921 is directly acquired by the transfer destination device 122.

In the data transfer control operation, the bus interface control signal 596, the transfer request command 597, an address generating circuit control signal 595, the data output enable signal 1891 supplied to the transfer source device 921, and also, the bus switch signal 1890 supplied to the transfer destination device 122 are outputted from the control signal generating circuit 1820. The address generating circuit control signal 595 corresponds to a signal used to perform a selecting control operation for a bus to which a transfer source address and a transfer destination address are outputted, and also used to control address generation timing. The address generating circuit 530 is operated in response to this address generating circuit control signal 595.

The data output enable signal 1891 corresponds to a signal used to control outputting operation of data with respect to the transfer source device 921. Concretely speaking, this data output enable signal 1891 corresponds to a signal capable of controlling that when the bus master 1800 outputs any one of the address outputted to the transfer source device, and the address outputted to the transfer destination device to the data bus 131 so as to access this data bus 131, the address outputted from the bus master 1800 does not collide with the data outputted from the transfer source device 921. The transfer source device 921 outputs the data to the data bus 131 in response to this data output enable signal 1891.

Also, the bus switch signal 1890 corresponds to such a signal for controlling the following operation: That is, since both the address and the data are outputted to the data bus 131 which are used to access the transfer destination device 122, when the transfer destination address is outputted onto the data bus 131, the address derived from the data bus 131 is inputted with having a top priority, whereas when the data derived form the transfer source device is outputted onto the data bus 131, the data derived from the data bus 131 is inputted having a top priority. The transfer destination device 122 switches a bus to be used in response to the bus switch signal 1890.

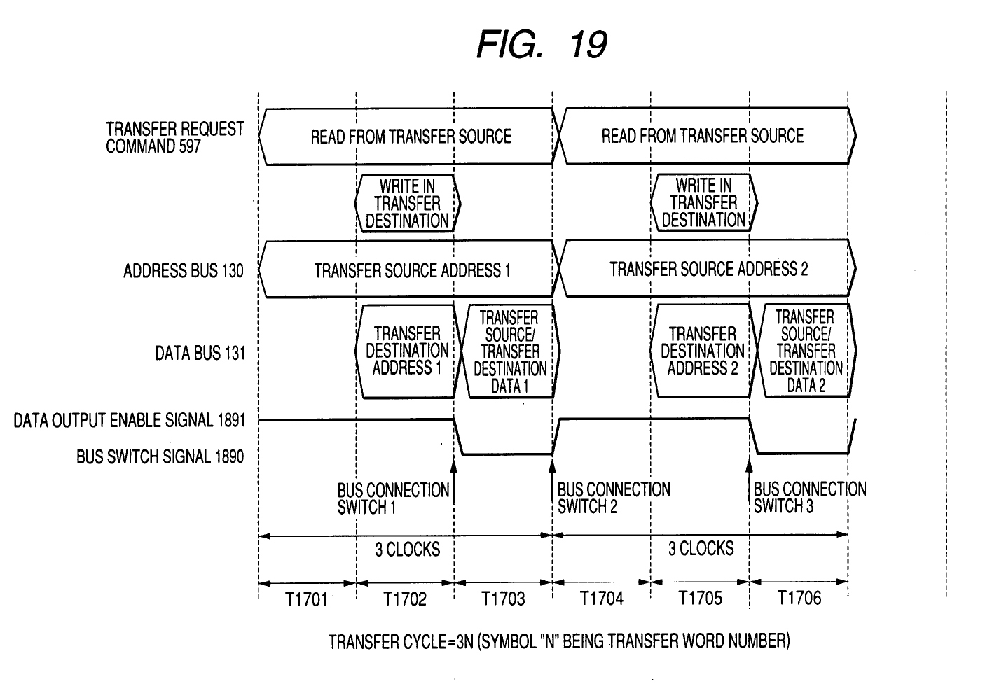

FIG. 19 is a timing chart for representing changes contained in a transfer request command, an address bus, a data bus, a data output enable signal, and a bus switch signal in the data transfer operation. In this data transfer operation, a data read operation from a transfer source device requires 3 cycles, and a data write operation to a transfer destination device requires 2 cycles.

When the data transfer control operation by the bus master 1800 is initiated, the data transfer control means 1810 makes such a judgement based upon the data transfer information as follows: That is, since the transfer source device 921 is such a device which is not operable in the pipeline transfer mode and is capable of controlling data output operation, and also, the transfer destination device 122 is such a device which is operable in the pipeline transfer mode and which is capable of switching the buses, such a data transfer operation is carried out between such devices that a data read operation from a transfer source device corresponds to 3 cycles and a data write operation to a transfer destination device corresponds to 2 cycles. Then, the data transfer control means 1810 controls access timing to the transfer destination device in such a manner that both the data output timing in the transfer source device 921 and the data input timing in the transfer destination device 122 become the same cycles. The data transfer information contains information as to the data transfer system of the transfer source device 921, the data transfer system of the transfer destination device 122, the transfer latency of the transfer source device 921, minimum transfer latency of the transfer destination device 122, and the like, which have been set to the transfer information holding unit 111.

In other words, the data transfer control means 1810 starts to output the transfer source address to the address bus 130 in a first cycle (T1701), and then, outputs the transfer source address and, at the same time, outputs the transfer destination address to the data bus 131 in the next cycle (T1702). At this time, since the transfer destination address has been outputted to the data bus 131, the transfer destination device 122 enters an address from the data bus 131 in response to the bus switch signal 1890.

In a next cycle (T1703), such a data is outputted which is transferred from the transfer source device 921 to the data bus 131 in response to the data output enable signal 1891. At this time, since the data to be transferred has been outputted to the data bus 131, the data is inputted from the data bus 131 in response to the bus switch signal 1890 at timing of a bus connection switch-1 (namely, when cycle T1702 is changed into cycle T1703). As previously explained, since both the transfer source address and the transfer destination address are outputted at the same time by using the data bus 131, and also, the access control operations are simultaneously carried out with respect to both the transfer source device and the transfer destination device, the data outputted from the transfer source device 921 is directly acquired by the transfer destination device 122.

Since such a data transfer control operation is carried out, a total cycle number required until the data of the transfer source device 921 is stored into the transfer destination device 122 is equal to 3 cycles, and since this data transfer operation is repeatedly performed in the pipeline transfer mode, a data transfer cycle becomes (3N) cycles in which symbol “N” indicates a transfer word number. In the case that this data transfer cycle of (3N) is compared with the data transfer cycle number (2N+3N) of the prior art having the same slave devices (see FIG. 14), in which symbol “N” indicates the transfer word number, this data transfer cycle of (3N) is largely shortened. Furthermore, even when this data transfer cycle of (3N) is compared with the data transfer cycle of (1N+3N) of the embodiment mode 4, in which symbol “N” shows the transfer word number, the embodiment mode 6 may achieve an effect.

In accordance with the data transfer apparatus 1800 of the embodiment mode 6, since the data buffer for temporarily buffering the data is not provided, the data transfer time can be omitted. Also, since the addresses are simultaneously outputted by employing the data bus with respect to both the transfer source device and the transfer destination device, the address output cycle number with respect to one of the slave devices can be omitted, so that the data transfer time can be further shortened. As a result, the operation cycle number required for the data transfer operation can be reduced, and thus, the data transfer efficiency can be improved.

It should be understood that the data transfer operation of the data transfer apparatus shown in FIG. 18 is merely one example. Therefore, even in a data transfer operation between devices having other transfer latency than the above-described transfer latency, a high-speed data transfer operation may be alternatively realized without via a data buffer by controlling the address output timing in such a manner that both the data output timing in the transfer source device 921 and the data input timing in the transfer destination device 122 become the same cycle.

Also, in the embodiment mode 6, the transfer source device 921 corresponds to such a device which is not operable in the pipeline transfer mode and is capable of controlling the data output, whereas the transfer destination device 122 corresponds to such a device which is operable in the pipeline transfer mode, and is capable of controlling the bus switching operation. However, the present invention is not limited only to such an arrangement. That is, as explained above, at least any one of the transfer source device 921 and the transfer destination device 122 may be such a device which is operable in the pipeline transfer mode, and is capable of switching the buses, while the transfer source device 921 is such a device which is capable of controlling the data output operation. Furthermore, in the embodiment mode 6, the slave device performs both the bus switching control operation and the data outputting control operation. Alternatively, while a bus controller is provided with the bus master, the bus master may perform both the buses switching control operation and the data outputting control operation.

Since the data transfer apparatus and the data transfer method, according to the present invention, are arranged in such a manner that while the data buffer is not provided with the bus master, when the data transfer control operation is carried out by the bus master, the data is directly transferred from the transfer source slave device to the transfer destination slave device, such a data transfer time used to store the data into the data buffer employed in the bus master can be omitted, and thus, the data transfer time can be shortened. Also, since the data buffer is not employed in the data transfer apparatus, the circuit scale thereof can be reduced, and therefore, the mounting cost can be suppressed. As explained above, both the effect capable of increasing the data transfer speed and the effect capable of reducing the circuit scale can be achieved. The inventive idea of the present invention may be useful as such a data transfer apparatus and a data transfer method, in which a data transfer operation among two, or more slave devices connected to a bus is carried out by a bus master.

1. A data transfer apparatus for transferring data between two, or more slave devices connected to a bus by a bus master, comprising:
a data transfer controller, which controls the bus in such a manner that data of a transfer source slave device is directly transferred to a transfer destination slave device in response to transfer information of the transfer source slave device and transfer information of the transfer destination slave device.

2. A data transfer apparatus according to claim 1, wherein:
the data transfer controller controls the bus in response to a difference between transfer latency of the transfer source slave device and transfer latency of the transfer destination slave device.

3. The data transfer apparatus as claimed in claim 2 wherein:
the data transfer controller controls the bus in response to transfer information outputted from the transfer source slave device and transfer information outputted from the transfer destination slave device.

4. The data transfer apparatus as claimed in claim 2 wherein:
the data transfer controller is comprised of a holder holding the transfer latency.

5. The data transfer apparatus as claimed in claim 4 wherein:
the data transfer controller controls the bus in response to the transfer latency held in the holder, or the transfer information outputted from the slave device.

6. The data transfer apparatus as claimed in claim 2 wherein:
the data transfer controller sends a master ready signal used to control the transfer latency of the slave devices to either the transfer source slave device or the transfer destination slave device.

7. The data transfer apparatus as claimed in claim 2 wherein:
the data transfer controller controls the bus in such a manner that the slave device, the transfer latency of which is small, is brought into a waiting state.

8. The data transfer apparatus as claimed in claim 2 wherein:
the data transfer controller sends a data output enable signal for controlling data output operation of the transfer source slave device, and sends a signal for switching address input operation of the transfer destination slave device.

9. The data transfer apparatus as claimed in claim 2 wherein:
the data transfer apparatus performs the data transfer operation between the slave devices in both a pipeline transfer mode and a data parallel transfer mode.

10. A data transfer method in which data is transferred between two, or more slave devices connected to a bus by a bus master, comprising:
a first step of acquiring transfer information of the transfer source slave device and transfer information of a transfer destination slave device; and
a second step of controlling access timing of the bus in such a manner that the data of the transfer source slave device is directly transferred to the transfer destination slave device in response to the transfer information.

11. The data transfer method as claimed in claim 10 wherein:
the second step includes:
a step of calculating a difference between transfer latency of the transfer source slave device and transfer latency of the transfer destination slave device; and
a step in which when the transfer latency of the transfer source slave device is smaller than the transfer latency of the transfer destination slave device, a data input operation of the transfer destination slave device is commenced; after a time period of the difference between the transfer latency has elapsed, a data output operation of the transfer source slave device is performed; when the transfer latency of the transfer source slave device is larger than the transfer latency of the transfer destination slave device, a data output operation of the transfer source slave device is commenced; and after the time period of the difference between the transfer latency has passed, a data input operation of the transfer destination slave device is carried out.
